(19) United States
(12) Patent Application Publication
(10) Pub. No.: US 2025/0069778 A1
(43) Pub. Date: Feb. 27, 2025

(54) FLAT CURLED CORD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kenichiro ARAKI, Mie (JP); Toyoki FURUKAWA, Mie (JP)

(21) Appl. No.: 18/720,944

(22) PCT Filed: Dec. 22, 2022
(86) PCT No.: PCT/JP2022/047268

§ 371 Date: Jun. 17, 2024

(30) Foreign Application Priority Data
Dec. 27, 2021 (JP) 2021-213214

(51) Int. Cl. H01B 7/08; H01B 7/00

(52) U.S. Cl. CPC H01B 7/0892; H01B 7/0045

(57) ABSTRACT

A flat curled cord 1 is formed by winding an insulated wire 2 into a helical shape, the insulated wire 2 including a conductor 12 and an insulation coating 13 covering the outer periphery of the conductor 12. The insulated wire 2 is a flat wire including the conductor 12 and the insulation coating 13 along an axial direction each having a flat cross-sectional shape. Flat surfaces, which are outer side surfaces of the flat wire 2 along a width direction of the flat shape, are facing outward and inward of the helical shape.

### TECHNICAL FIELD

The present disclosure relates to a flat curled cord.

### BACKGROUND

A stretchable curled cord formed by helically winding an insulated wire is known. The curled cord of this type is used for applications such as electrical connection between movable members and, for example, arranged in a part where a wire is required to be stretchable such as a slide door or a rear window in an automotive vehicle. Patent Document 1 can be cited as illustrating a curled cord.

### PRIOR ART DOCUMENT

### Patent Document

Patent Document 1: JP 2012-243399 A

### SUMMARY OF THE INVENTION

### Problems to be Solved

Since a curled cord is formed by helically winding an insulated wire, a large space is required for routing as compared to the case of using the linear insulated wire as it is. That is, when the curled cord having a certain length as a natural length and the linear insulated wire having the same length are compared, the curled cord occupies a larger space in a radial direction. As described above, the curled cord can be suitably used for a movable part of a device such as an automotive vehicle. However, in terms of enabling wire routing also in a narrow space in various devices such as automotive vehicles, various wires are advantageously highly space saving. The curled cord is also desired to improve space saving by reducing a diameter. Here, if a conductor cross-sectional area of the insulated wire constituting the curled cord is reduced or if a helix diameter of the curled cord is reduced, there is a possibility that a diameter reduction can be achieved. However, in that case, the springiness of the curled cord is reduced (spring constant is reduced), and it possibly becomes difficult to ensure a sufficient restoring force in an expanding/contracting motion. It is desired to achieve a diameter reduction while high springiness of the curled cord is maintained.

In view of the above, it is aimed to provide a curled cord achieved with a diameter reduction and a wiring harness including such a curled cord.

### Means to Solve the Problem

A flat curled cord according to the present disclosure is formed by winding an insulated wire into a helical shape, the insulated wire including a conductor and an insulation coating covering an outer periphery of the conductor, the insulated wire being a flat wire including the conductor and the insulation coating along an axial direction each having a flat cross-sectional shape, and flat surfaces facing outward and inward of the helical shape, the flat surfaces being outer side surfaces of the flat wire along a width direction of the flat shape.

A wiring harness of the present disclosure includes the flat curled cord.

### Effect of the Invention

The flat curled cord according to the present disclosure is a curled cord achieved with a diameter reduction while ensuring springiness. Further, the wiring harness according to the present disclosure includes such a curled cord.

### BRIEF DESCRIPTION OF THE DRAWINGS

FIG. 1A is a side view showing a flat curled cord according to one embodiment of the present disclosure, FIG. 1B is a section showing a cross-section of a flat wire constituting the flat curled cord cut perpendicular to an axial direction and FIG. 1C is a front view of the flat curled cord.

FIG. 2 is a perspective view showing a conductor of the flat wire constituting the flat curled cord according to the embodiment of the present disclosure.

FIG. 3A is a side view showing a round curled cord adopting a round wire having a circular cross-section intersecting an axial direction as the curled cord, and FIG. 3B is a section intersecting the axial direction of the round wire.

FIG. 4A is a section of the flat curled cord according to the embodiment of the present disclosure cut along a center axis of a helical shape, FIG. 4B is a section of the round curled cord including a substantially circular conductor and cut along a center axis of a helical shape, and FIG. 4C is a diagram comparing the flat curled cord and the round curled cord, an internal structure of the wire being not shown in a cross-section.

FIGS. 5A and 5B are graphs showing relationships of a flatness ratio and an outer diameter of the flat curled cord and the round curled cord, wherein FIG. 5A is a graph of a curled cord having an inner diameter I of 3 mm in FIG. 1C and a circle equivalent wire diameter of 1.6 mm and FIG. 5B is a graph of a curled cord having an inner diameter I of 3 mm and a circle equivalent wire diameter of 3 mm, and FIG. 5C is a graph showing relationships of a turn number and the flatness ratio necessary to fabricate a flat curled cord and a round curled cord having an entire length of 150 mm.

FIG. 6 is a graph showing relationships of a tensile force and a displacement for the flat curled cord and the round curled cord.

### DETAILED DESCRIPTION TO EXECUTE THE INVENTION

### Description of Embodiments of Present Disclosure

First, embodiments of the present disclosure are described.

A flat curled cord according to an embodiment of the present disclosure is formed by winding an insulated wire into a helical shape, the insulated wire including a conductor and an insulation coating covering an outer periphery of the conductor, the insulated wire being a flat wire including the conductor and the insulation coating along an axial direction each having a flat cross-sectional shape, and flat surfaces facing outward and inward of the helical shape, the flat surfaces being outer side surfaces of the flat wire along a width direction of the flat shape.

In the above flat curled cord, the curled cord is constituted by the flat wire and wound such that the flat surfaces of the flat wire, i.e. surfaces parallel to the width direction of the flat shape, face inward and outward of a helical structure. In this helical structure, the flat surfaces of the flat wire are so arranged that the width direction is along a center axis of the curled cord. Since a dimension in a height direction intersecting the width direction is smaller than a diameter of a substantially circular cross-section (round wire) having the same conductor cross-sectional area in the flat wire, a thickness of the helical shape occupying in a radial direction is small. Thus, when the curled cords obtained by helically winding the flat wire and the round wire into helical shapes having the same inner diameter are compared, an outer diameter of the curled cord is smaller in the case of using the flat wire and a diameter reduction of the flat curled cord can be realized. As described above, the flat curled cord has a smaller outer diameter than the curled cord using the round wire having the same conductor cross-sectional area. If the flat curled cord has the same natural length as shown in Examples later, a nearly equal spring constant is ensured.

A flatness ratio representing a ratio of a length in a height direction to a length in the width direction may be 0.79 or less for an entire shape of the flat wire if the height direction is a direction intersecting the width direction of the flat shape. If the flatness ratio is 0.79 or less, a curled cord diameter reduction effect can be improved. Further, if the flatness ratio is 0.79 or less, the dimension in the width direction of the flat wire is longer than a diameter of a wire (round wire) having a substantially circular cross-section having the same conductor cross-sectional area, and occupies a larger length in a direction along the center axis of a helix. Thus, in the case of forming curled cords having the same natural length using the flat wire and the round wire, an actual length of the wire used can be reduced and a conductor usage can be reduced since a length of the wire occupying each turn along the axis of the helical shape is larger if the flat wire is used. That is, the curled cord can be reduced in weight.

The conductor may be constituted by a stranded wire formed by twisting a plurality of strands. By using the stranded wire formed by twisting the plurality of strands as the conductor, the flat wire can be easily formed into the helical shape. Further, the conductor is preferably constituted by the stranded wire since flexibility when the curled cord is expanded and contracted can be enhanced.

If a round curled cord is formed by winding a round wire having the same conductor cross-sectional area and insulation coating thickness as the flat wire and having a circular cross-section intersecting an axial direction into a helical shape in such a manner as to have the same inter-turn interval and inner diameter of the helical shape as the flat curled cord, an outer diameter of the helical shape of the flat curled cord may be 90% or less of an outer diameter of the helical shape of the round curled cord. Then, a diameter reduction of the flat curled cord is sufficiently achieved as compared to the round curled cord.

A spring constant of the flat curled cord may be 90% or more of a spring constant of the round curled cord. Since there is no significant difference between the spring constants of the flat curled cord and the round curled cord, the flat curled cord can ensure a restoring force nearly equal to that of the round curled cord, and the flat curled cord can be suitably routed in a part required to be stretchable.

A wiring harness according to this embodiment includes the flat curled cord. The wiring harness applied with the flat curled cord can be suitably used for the wiring of movable parts of various devices such as a slide door and a rear window in an automotive vehicle.

### Details of Embodiment of Present Disclosure

Hereinafter, a flat curled cord according to one embodiment of the present disclosure is described in detail using the drawings.

### (Overall Configuration of Flat Curled Cord)

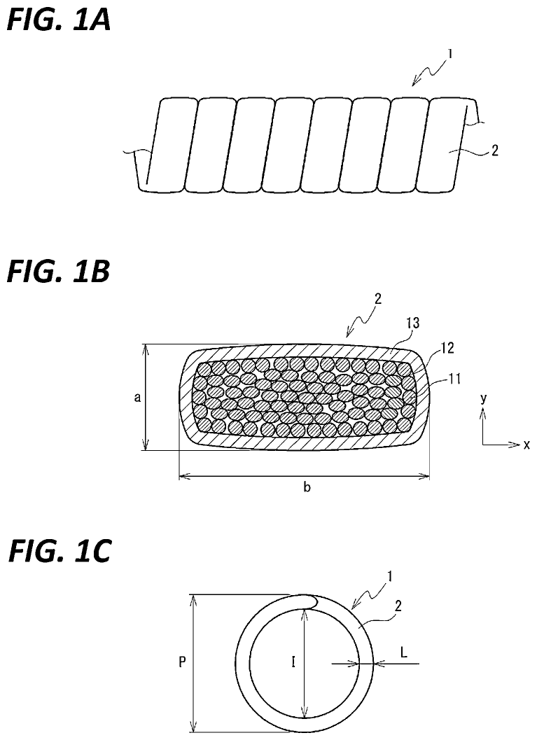

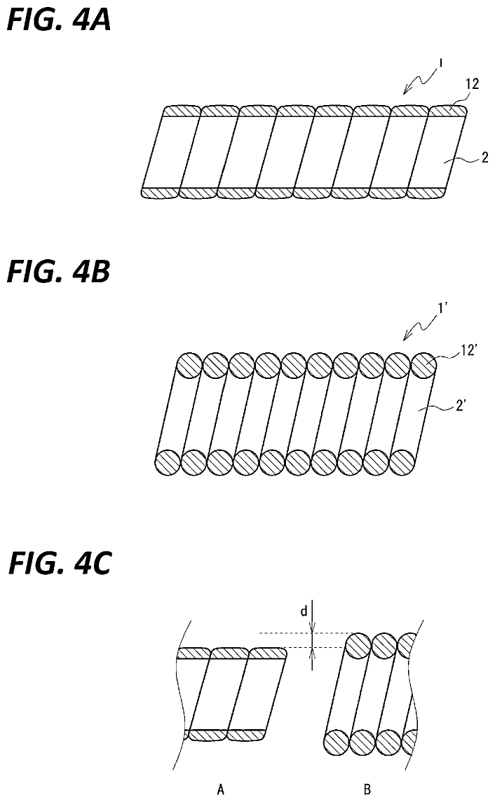

FIG. 1A is a side view showing a flat curled cord 1 according to the embodiment of the present disclosure. FIG. 1B is a section showing a flat wire 2 constituting the flat curled cord 1 cut along a plane perpendicular to an axial direction. FIG. 1C is a front view showing the flat curled cord 1. Further, FIG. 4A is a section of the flat curled cord 1 cut along a center axis of a helical shape. Note that, in the present disclosure, the axial direction of the flat wire 2 is a wire extension direction in the flat wire 2, and the center axis of the flat curled cord 1 is an axis passing through a helix center of the flat curled cord.

The flat curled cord 1 is configured by helically winding the flat wire 2. As described in detail next, the flat wire 2 is a wire having a flat cross-sectional shape intersecting the axial direction. In the flat curled cord 11, flat surfaces, which are outer side surfaces of the flat wire 2 along a direction of a width b (width direction x) of the flat shape, are facing outward and inward of the helical shape. As long as the flat wire 2 constituting the curled cord 1 has a flat shape, the shape of an entire helical structure is not particularly limited, but is preferably a substantially cylindrical shape. As described above, if the flat surfaces are facing outward and inward of the helical shape in the flat curled cord 1, the flat surfaces of the flat wire 2 are so arranged that the width direction (x direction) extends substantially along a direction (stretching direction) of the center axis of the helical shape in each helical turn. In other words, the flat curled cord 1 is configured such that the turns in contact are adjacent along the width direction x of the flat shape to form the helical shape.

The flat wire 2 constituting the flat curled cord 1 includes a conductor 12 and an insulation coating 13 as shown in FIG. 1B. The outer periphery of the conductor 12 is covered by the insulation coating 13. The flat wire 2 has a flat cross-sectional shape orthogonal to the axial direction. Preferably, the cross-sectional shape of the flat wire 2 may be approximated to a rectangular shape. In the flat wire 2, not only the entire shape, i.e. the shape of the entire flat wire 2 including the conductor 12 and the insulation coating 13, has a flat shape, but also the conductor 12 itself has a flat shape in the cross-section orthogonal to the axial direction. In this embodiment, the entire flat wire 2 and the conductor 12 have the flat shape as described above in an entire region constituting the helical shape of the flat curled cord 1.

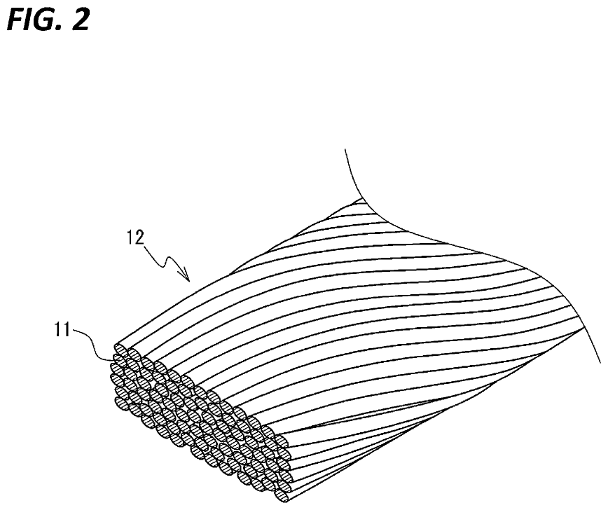

In the flat wire 2, the conductor 11 is made of metal such as copper, copper alloy, aluminum or aluminum alloy, and the insulation coating 13 is made of an insulating polymer material or the polymer material further added with an additive such as a filler. The conductor 12 may be constituted by a single wire. However, in terms of enhancing formability into a helical shape and the stretchability of the curled cord, it is preferred to use the conductor 12 constituted by a stranded wire of a plurality of strands 11. An example of the conductor 12 configured as a stranded wire and having a flat shape is shown in a perspective view of FIG. 2. Note that, in each figure, the wire conductor 12 is shown to be composed of less strands 11 than actual typical flat wires.

In manufacturing the flat wire 2, the plurality of strands 11 twisted to have a substantially circular cross-section are rolled to have a flat cross-section, whereby the conductor 12 can be formed. By coating a polymer composition, which will become the insulation coating 13, on the entire periphery of the conductor 11 by extrusion molding or the like, the flat wire 2 can be provided. The flat wire 2 obtained in this way is wound into a helical shape, such as by being wound on the outer periphery of a round bar, whereby the curled cord 1 can be manufactured. At this time, the flat wire 2 is wound into the helical shape with a direction of the flat wire 1 set such that the flat surfaces along the width direction x face inward and outward of a helix.

Note that, in this embodiment, a multi-core cable including a plurality of insulated wires may be used as the flat wire 2 to be formed into a helical shape and a multi-core curled cord may be formed. However, also in that case, not only the multi-core cable configured as an aggregate including the plurality of insulated wires has a flat shape, but also each insulated wire and each conductor 11 themselves have a flat shape, and the width direction x of those flat shape is oriented in a direction along a center axis of a helix. Preferably, in terms of the simplification of the configuration and the like, the single flat wire 2, in which the outer periphery of one flat conductor 12 is covered by the insulation coating 13, may be helically wound to form the flat curled cord 1 as shown.

Further, in the flat curled cord 1, another member may be provided between the respective members and on the outer peripheries of the members as appropriate, besides the constituent members described above, i.e. the conductor 12 and the insulation coating 13. The other member can be, for example, another wire material arranged on the outer periphery of the flat wire 12 formed into the helical shape like an example of a steel wire integrated with a sheath of the insulated wire processed into a helical shape and helically plastically deformed as described in Patent Document 1. However, in terms of reducing a diameter and enhancing weight saving of the flat curled cord 1, it is preferred not to provide any member other than the conductor 12 and the insulation coating 13 described above.

### (Details of Shape of Flat Curled Cord)

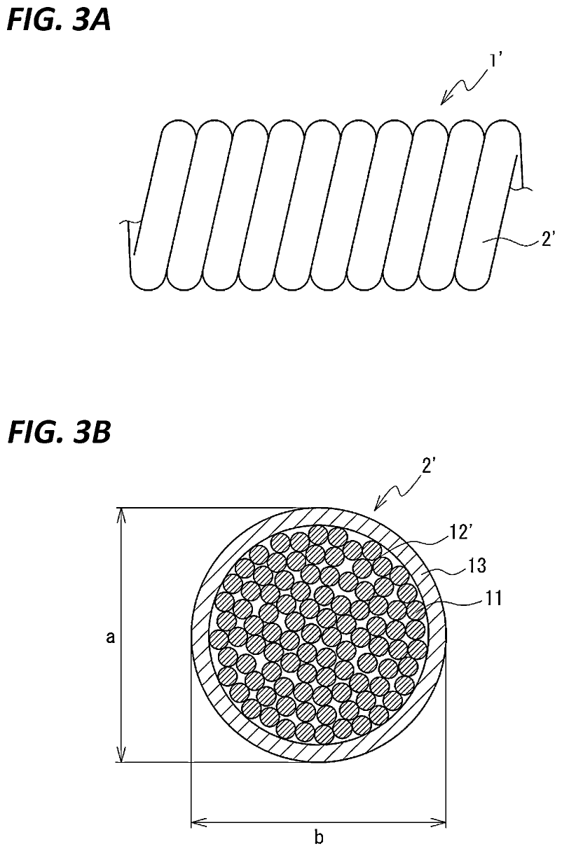

Here, the details of the shape of the flat curled cord 1 and characteristics of the flat curled cord brought about by that shape are described in comparison to a round curled cord 1′. Here, the round curled cord 1′ to be compared is shown in FIGS. 3A and 3B. FIG. 3A is a side view of the round curled cord 1′ and FIG. 3B is a section of a round wire 2′ constituting the round curled cord cut perpendicular to an axial direction. The round curled cord 1′ is formed by winding the round wire 2′ having the same conductor cross-sectional area and insulation coating thickness as the flat wire 2 and having a substantially circular cross-sectional shape intersecting the axial direction into a helical shape having the same interval (zero in the shown example) between turns of the helical shape and inner diameter (I) as the flat curled cord 1.

Since the flat curled cord 1 according to this embodiment is formed by winding the flat wire 2 such that the flat surfaces face inward and outward of the helix, a length a in a height direction y of the flat wire 2 occupies a radial thickness (dimension L in FIG. 1C) of the helix. If the round curled cord 1′ and the flat curled cord 1 having the same conductor cross-sectional area are compared, the flat curled cord 1 has a smaller thickness L in the radial direction of the helix than the round curled cord 1′ since a height a of the flat wire 2 is smaller than a diameter of the round curled cord 1′. At this time, if inner diameters I of the curled cords are equal, an outer diameter P of the flat curled cord 1 is suppressed to be small. FIG. 4C shows the comparison of the outer diameters of the flat curled cord 1 (A) and the round curled cord 1′ (B). If d denotes a length equivalent to a difference between lengths b in the width direction of the flat wire 2 and the round wire 2′, the outer diameter of the flat curled cord 1 is smaller than that of the round curled cord 1′ by a length 2d. Thus, the use of the flat wire 2 to form the curled cord having the same inner diameter is better in reducing a wire diameter.

In the flat curled cord 1 according to the embodiment of the present disclosure, the flat wire 2 is wound such that the flat surfaces face inward and outward of the helix. Since the width direction x of the flat wire 2 is substantially oriented in the direction along the center axis of the helix in that way, a length occupied in the axial direction of the helix by the flat wire 2 in each turn of the helix is a large dimension corresponding to the width b of the flat shape. Here, if a ratio of the length (a) in the height direction to the length (b) in the width direction of the flat surfaces of the conductor 12 of the flat wire 2 is a flatness ratio (a/b), the dimension b in the width direction of the flat wire 2 becomes longer than the outer diameter of the round wire 2′ having the same conductor cross-sectional area and insulation coating thickness and occupies a longer length in the direction along the center axis of the helix as described in Examples later if the flatness ratio is 0.79 or less. That is, the flat curled cord 1 using the flat wire 2 having a flatness ratio of 0.79 or less has a larger length occupying in the axial direction of the helix in each turn than the round curled cord 1′ using the round wire 2′ having the same conductor cross-sectional area. Thus, if the flat wire 2 having a flatness ratio of 0.79 of less is used in forming the curled cord of the same length (natural length), the number of turns is suppressed to be smaller than in the case of using the round wire 2′, wherefore an actual length of the wire can be short and a conductor usage can be reduced. A total volume of the insulation coating 13 can also be reduced. As effects of those, the weight saving of the curled cord is achieved.

In the flat curled cord 1, the length occupying in the width direction of the helix in the flat wire 2 may be increased to make the actual length of the flat wire 2 to be used even shorter in terms of enhancing an effect of reducing the conductor usage and the like. That is, the length (b) in the width direction X may be increased in the flat shape of the flat wire 2. Further, the thickness in the radial direction of the helix may be reduced to make the outer diameter P of the flat curled cord 1 even smaller in terms of reducing the diameter of the flat curled cord 1. That is, the length (a) in the height direction y may be reduced in the flat wire 2. Here, when the flatness ratio of the flat wire 2 is 0.79 or less as described above, the actual length of the wire can be short and the conductor usage can be reduced as compared to the case of using the round wire 2′. To further enhance the effect of reducing the conductor usage and reducing the diameter, the flatness ratio may be made smaller than 0.79. For example, the flatness ratio may be set to 0.5 or less. On the other hand, if the value of the flatness ratio becomes too small, it is difficult to maintain the entire shapes of the conductor 12 and the flat wire 2. Thus, the flatness ratio is preferably 0.1 or more in terms of ensuring durability enabling use as the curled cord.

Note that, in the case of forming the insulation coating 13 by extrusion molding, it also has an effect of enhancing the thickness uniformity of the insulation coating 13 that the conductor 12 has the flat cross-sectional shape. Since flat surfaces are formed in the vertical direction on the outer peripheral surface of the conductor 12 having the flat shape, the insulation coating 13 covering the outer periphery of the conductor 11 is easily formed to have a uniform thickness in each part. By enhancing the thickness uniformity of the insulated wire 13, characteristics such as wear resistance can be ensured even if the entire insulation coating 13 in the flat wire 2 is formed to be thin. Thus, the insulation coating 13 can be thinned along with a reduction in the conductor usage, which is effective in reducing the weight of the flat curled cord 1.

The flat curled cord 1 according to this embodiment has a smaller outer diameter than the round curled cord 1′ having the same conductor cross-sectional area and natural length as described above. Further, when the flatness ratio of the flat wire 2 of the flat curled cord 1 is 0.79 or less, the conductor usage is reduced as compared to the round curled cord 1′. Generally, spring resilience depends on a metal material usage and a helix diameter. However, in the flat curled cord 1 according to this embodiment, a spring constant nearly equal to or close to (e.g. 90% or more) that of the round curled cord 1′ can be ensured as confirmed in Examples later. In that way, the flat curled cord 1 can ensure high springiness. Therefore, a sufficient restoring force is obtained in an expanding/contracting motion of the flat curled cord 1.

In the flat curled cord 1, the diameter of each strand 11, the dimensions of the entire conductor 12, the specific helical shape of the flat curled cord 1 and the like may be determined as appropriate in consideration of required resilience (springiness), conductivity and the like, but the following ranges can be cited as suitable examples.
Diameter of the stands 11:50 to 250 μm
Conductor dimensions: 0.80 to 1.13 mm (length in the height direction y), 2.25 to 3.19 mm (length in the width direction x)
Helix pitch: 1.12 to 16.85 mm
Helix turn interval: 0 to 15 mm

### (Wiring Harness)

A wiring harness according to one embodiment of the present disclosure is also briefly described. The wiring harness according to this embodiment is configured by mounting a connecting member such as a terminal on the flat curled cord 1 according to the embodiment of the present disclosure described above and/or by combining the flat curled cord 1 with another wire. Such a wiring harness can be suitably routed in movable parts of various devices. The use of the flat curled cord realizing a diameter reduction and a reduction in the conductor usage while ensuring springiness can also contribute to the weight saving and diameter reduction of the wiring harness. In the field of automotive vehicles, the weight saving of constituent members is an important issue, and the wiring harness according to this embodiment can be suitably used in a slide door, a rear window and the like of an automotive vehicle.

### Examples

Examples are described below. Note that the present invention is not limited by these Examples.

### (1) Evaluation of Diameter Reduction of Curled Cord

### <Evaluation Method>

The outer diameter P shown in FIG. 1C when the flatness ratio of the flat curled cord was changed from 0.1 to 1.0 was estimated. Further, the outer diameter P of the round curled cord having the same conductor cross-sectional area as the flat curled cord was also estimated in a method similar to that for the flat curled cord. Samples of the flat curled cord were F1, F2, and samples of the round curled cord were R1, R2. In Samples F1, F2 and Samples R1, R2, the inner diameter I is equal at 3 mm, but the circle equivalent wire diameters of Sample F1 and Sample R1 are 1.6 mm, and those of Sample F2 and Sample R2 are 3 mm. Here, the circle equivalent diameter indicates a diameter of a circle having the same cross-sectional area as the target wire, and is equivalent to the diameter of the cross-section in the case of the round curled cord.

In estimating the outer diameter P, the dimension b in the width direction of the flat wire constituting the flat curled cord was calculated from the circle equivalent wire diameter and the flatness ratio. In the case of the round curled cord, the circle equivalent wire diameter itself was set as the dimension b in the width direction. Then, the outer diameter P was estimated, assuming that a coating having a thickness b was formed on the outer periphery of a hollow cylinder having a predetermined inner diameter I. That is, the outer diameter of the curled cord P was estimated by P=I+2b.

### <Result>

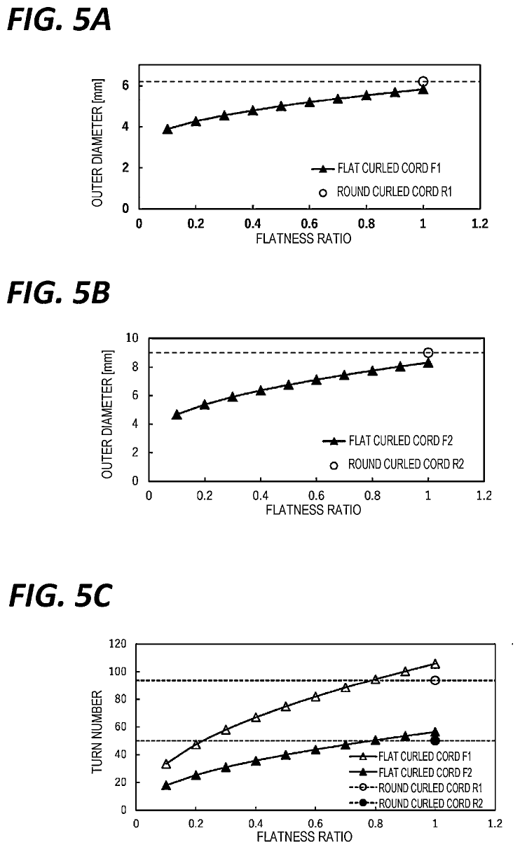

FIGS. 5A and 5B are graphs with the flatness ratio of each sample represented by a horizontal axis and the calculated outer diameter P represented by a vertical axis. The outer diameter P of the flat curled cord at each flatness ratio is indicated by a triangle mark. Further, the outer diameter P of the round curled cord is also indicated by a circle mark in figures.

In either one of FIGS. 5A and 5B, plot points in the case of using the flat wire are below outer diameter values in the case of using the round wire and it is confirmed that the outer diameter P is reduced by applying not the round wire, but the flat wire to the curled cord. Further, the diameter reduction effect increases as the flatness ratio is reduced (as a flattening degree is increased). For example, if the outer diameters P of the flat curled cord Sample F1 and the round curled cord Sample R1 are compared in FIG. 5A, the outer diameter P of Sample F1 is smaller than that of Sample R1 by about 37% (outer diameter reduction rate) when the flatness ratio is 0.1. Note that the flat wire having a flatness ratio of 1 in the graph indicates a case where the length (b) in the width direction and the length (a) in the height direction are equal, i.e. a case where a cross-section has a square shape. The round wire also has a flatness ratio of 1, but the outer shape P of the curled cord is larger in the case of using the round wire than in the case of using the flat wire having a flatness ratio of 1 since the round wire and the flat wire have the same cross-sectional area and a diameter of a circle having the same area as a square is larger than a length of a side of the square.

Next, results of FIGS. 5A and 5B are compared. The inner diameter I of the curled cord is the same in both cases, but the cross-sectional area (circle equivalent wire diameter) of the wire used is larger in FIG. 5B. If the outer diameter reduction rates of the flat curled cord F1 of FIG. 5A and the flat curled cord F2 of FIG. 5B respectively from the round curled cords R1, R2 are compared when the flatness ratio is equal, the flat curled cord F2 clearly has a larger outer diameter reduction rate at each flatness ratio. That is, as the cross-sectional area of the wire increases, the diameter reduction effect when the flat curled cord is used in place of the round curled cord is larger. For example, if the outer diameter reduction rates of the both samples at a flatness ratio of 0.1 are compared, Sample F1 has an outer diameter reduction rate of 37% and Sample F2 has an outer diameter reduction rate of 48% and Sample F2 has a larger outer diameter reduction rate by 11 points.

### (2) Evaluation of Conductor Usage in Curled Cord

### <Evaluation Method>

In terms of comparing the conductor usages in the flat curled cord and the round curled cord, helix turn numbers were estimated for a case where each curled cord is formed to have the same length. The helix turn numbers are substantially proportional to lengths of the conductors of the flat wire and the round wire used. The turn numbers of the respective curled cord samples having an entire length of 150 mm were estimated and compared for Samples F1, F2, R1 and R2 used in the evaluation (1). If the cross-sectional area of the insulated wire and the inner diameter of the curled cord are equal, the turn number of the helical shape of the curled cord is substantially proportional to an actual length and the conductor usage of the insulated wire constituting the curled cord. If a turn interval (width of a gap between parts of the insulated wires constituting adjacent turns) is zero, the turn numbers T can be estimated by T=150/b using the dimensions b in the width direction of the flat wire and the round wire.

### Result

FIG. 5C is a graph with the flatness ratio of each sample represented by a horizontal axis and the calculated turn number represented by a vertical axis. The turn number of the flat curled cord F1 at each flatness ratio is indicated by a white triangle mark, and that of Sample F2 is indicated by a black triangle mark. Further, the turn number of the round curled cord R1 is indicated by a white circle mark, and that of Sample R2 is indicated by a black circle mark.

In FIG. 5C, if the turn numbers T of the flat curled cord F1 and the round curled cord R1 are further compared to those of the flat curled cord F2 and the round curled cord R2, plot points in the case of using the flat wires having a flatness ratio of 0.1 to 0.8 are below the turn number T in the case of using the round wire, and it is confirmed that the turn number is reduced by applying not the round wire, but the flat wire to the curled cord. That is, a wire usage can be reduced by using the flat wire having a flatness ratio of 0.79 or less. This is because the length of the wire occupying each turn is increased since the flat wire has a longer dimension in the width direction than the round wire and the length occupying in the direction along the center axis of the helix increases when the flatness ratio is 0.1 to 0.79 or less. As described above, a reduction in the turn number means that the actual length of the wire used can be reduced and it was demonstrated from the result of FIG. 5C that the conductor usage could be reduced by using the flat curled cord fabricated from the flat wire having a flatness ratio of 0.79 or less. When the flatness ratio is 0.79 or less, a turn number reduction effect increases as the flatness ratio is reduced (as the flattening degree is increased) in the curled cords F1 and F2, wherefore a conductor usage reduction effect is also enhanced. Note that, in a region where the flatness ratio is 0.8 or more and less than 1, the cross-sectional area of the flat wire is laterally long, but close to a square shape and the dimension b in the width direction becomes larger than the corresponding dimension of the round wire, wherefore the turn number is larger than in the case of using the round wire. Here, that the turn number of the flat curled cord having a flatness ratio of 0.8 becomes larger than that of the round curled cord corresponds to a flatness ratio of a rectangle having a dimension b in the width direction, which is a diameter of a circle having the same area, precisely corresponds to a point where the flatness ratio is π/4, which is nearly equal to 0.79.

Next, Sample F1 and Sample F2 are compared. Although the inner diameters I of Sample F1 and Sample F2 are equal, Sample F2 has a larger wire cross-sectional area (circle equivalent wire diameter). If the turn number reduction rates of the flat curled cords F1, F2 respectively from the round curled cords R1, R2 in FIG. 5C are compared, the turn number reduction rate remains unchanged at each flatness ratio. That is, the conductor usage reduction effect when the round curled cord is replaced by the flat curled cord does not depend on the wire cross-sectional area. For example, if the turn number reduction rates of both Samples at a flatness ratio of 0.1 are compared, the both are 36%. The turn number reduction rate corresponds to the conductor usage reduction rate, and the conductor usage reduction effect when the round curled cord is replaced by the flat curled cord can be said to be obtained without depending on the wire cross-sectional area.

### (3) Spring Constant

### <Fabrication of Curled Cords>

A round curled cord and a flat curled cord including a conductor having a substantially circular cross-section as described below were fabricated and respectively set as a round curled cord R3 and a flat curled cord F3.

### <Round Curled Cord R3>

A conductor wire having a conductor cross-sectional area of 2 mm² was produced by twisting thirty seven copper alloy strands. A round insulated wire including an insulation coating having a thickness of 0.4 mm was fabricated by extrusion molding a polyvinyl chloride-based resin on the outer periphery of the obtained conductor. Subsequently, the insulated wire was helically wound on a straight bar member having an outer diameter of 7.8 mm with an inter-turn distance set to 2.6 mm, and Sample R3 of the round curled cord having an entire length of 150 mm was fabricated.

### <Flat Curled Cord F3>

A conductor wire was produced similarly to the round curled cord and the obtained conductor wire was rolled using a roller, thereby fabricating the conductor wire having a flat conductor cross-sectional shape and a flatness ratio of 0.28. A flat insulated wire (flat wire) including an insulation coating having a thickness of 0.4 mm was fabricated by extrusion molding on the outer periphery of the obtained similarly to the round curled cord. The flat wire was wound on a straight bar member having an outer diameter of 7.8 mm with an inter-turn distance set to 2.6 mm such that flat surfaces of the flat wire along a width direction of a flat shape face outward and inward of a helical shape, and Sample F3 of the flat curled cord having an entire length of 150 mm was fabricated. As described above, Sample R3 and Sample F3 have an equal natural length.

### <Evaluation Method>

A displacement amount was measured when one end of each of the flat curled cord F3 and the round curled cord R3 fabricated as described above was fixed and the other end is stretched by a predetermined tensile force, and a relationship of the displacement amount (mm) and the tensile force (N) was recorded. A spring constant of the curled cord was evaluated by obtaining a gradient of that recorded graph.

### Result

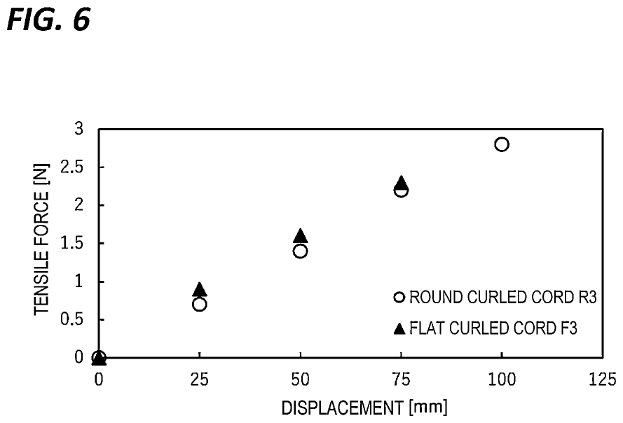

FIG. 6 shows tensile forces necessary when the curled cords of Sample F3 and Sample R3 are stretched (displaced) by a predetermined length. Plots of Sample F3 and Sample R3 can be both linearly approximated and take values very close to each other. If x (mm) denotes the displacement amount, F (N) denotes the tensile force and k denotes the spring constant, F=kx from Hooke's law and the spring constant k is obtained by k=F(N)×x (mm). Accordingly, if the gradient of the linear approximation curve is obtained and the spring constant k is calculated for each Sample, the spring constant k of the Sample F3 is 0.029 N/mm and that of Sample R3 is 0.031 N/mm. That is, Sample F3 has a spring constant, which is about 95% of that of Sample R3 and the spring constants of the both samples can be said to be nearly equal. Sample F3 includes the conductor of the flat wire having a flat shape and has a smaller total conductor amount than Sample R3 constituted by the round wire having an equal conductor cross-sectional area, but Sample F3 and Sample R3 have the same conductor cross-sectional area and natural length. Thus, even if the total conductor amount is small, equivalent springiness can be obtained if the conductor cross-sectional area and the natural length are the same.

As shown by the above result, the flat curled cord using the flat wire can realize a diameter reduction due to a reduction in the outer diameter while having springiness equivalent to that of the round curled cord having an equal conductor cross-sectional area. Particularly, the diameter reduction effect is increased by reducing the flatness ratio of the conductor and increasing the flattening degree, and that effect is more notable as the conductor cross-sectional area increases.

Although the embodiment of the present disclosure has been described in detail above, the present invention is not limited to the above embodiment at all and various changes can be made without departing from the gist of the present invention.

### LIST OF REFERENCE NUMERALS

1 flat curled cord
1′ round curled cord
2 insulated wire (flat wire)
2′ insulated wire (round wire)
11 strand
12 conductor
13 insulation coating
a length in height direction
b length in width direction
P outer diameter
I inner diameter
L thickness in radial direction of helical shape

1. A flat curled cord formed by winding an insulated wire into a helical shape, the insulated wire including a conductor and an insulation coating covering an outer periphery of the conductor,
the insulated wire being a flat wire including the conductor and the insulation coating along an axial direction each having a flat cross-sectional shape,
flat surfaces facing outward and inward of the helical shape, the flat surfaces being outer side surfaces of the flat wire along a width direction of the flat shape, and
if a round curled cord is formed by winding a round wire having the same conductor cross-sectional area and insulation coating thickness as the flat wire and having a circular cross-section intersecting an axial direction into a helical shape in such a manner as to have the same inter-turn interval of the helical shape, inner diameter and natural length as the flat curled cord,
a spring constant of the flat curled cord being 90% or more of a spring constant of the round curled cord.

2. The flat curled cord of claim 1, wherein a flatness ratio representing a ratio of a length in a height direction to a length in the width direction is 0.79 or less for an entire shape of the flat wire if the height direction is a direction intersecting the width direction of the flat shape.

3. The flat curled cord of claim 2, wherein the flatness ratio is 0.5 or less.

4. The flat curled cord of claim 1, wherein the conductor is constituted by a stranded wire formed by twisting a plurality of strands.

5. The flat curled cord of claim 1, wherein an outer diameter of the helical shape of the flat curled cord is 90% or less of an outer diameter of the helical shape of the round curled cord.

6. The flat curled cord of claim 1, wherein the cross-sectional shape of the flat wire is approximated to a rectangular shape.

7. A wiring harness, comprising the flat curled cord of claim 1.
